(19) United States
(12) Patent Application Publication
(10) Pub. No.: US 2022/0381013 A1
(43) Pub. Date: Dec. 1, 2022

(54) PORTABLE SHOWER

(71) Applicant: Charles Hinton, Philadelphia, PA (US)

(72) Inventor: Charles Hinton, Philadelphia, PA (US)

(21) Appl. No.: 17/303,520

(22) Filed: Jun. 1, 2021

(51) Int. Cl. E03C 1/04; B08B 3/02; B60S 3/04; B62B 3/10; B62B 5/06

(52) U.S. Cl. CPC E03C 1/0408; B08B 3/02; B60S 3/04; B62B 3/10; B62B 5/06; B08B 2203/007; B62B 2202/50

(57) ABSTRACT

A portable shower system includes a portable shower apparatus housed in a wheeled cart. The shower apparatus comprises a shower head, at least two water tanks, including a hot water tank and a cold water tank, and a plurality of pipes with valves operably connected to shower faucet knobs or handles. The hot water tank includes a water heater operably connected by power cords to a battery, solar panel, or combination thereof, for heating of water contained therein. The cart includes access doors for filling and maintenance of water tanks. Water pipes in fluid communication with the water tanks, a shower faucet and a shower head enable delivery of hot and cold water to the shower head, in response to use of faucet handles for hot and cold water. The invention provides a solution to the problem of a lack of portable shower facilities for indoor and outdoor use.

### BACKGROUND OF THE INVENTION

The present invention relates to housewares and plumbing, and more particularly, to a portable shower system.

Many situations and locations exist wherein a shower may be needed, though a shower is unavailable. Nonlimiting examples of such situations and locations may include when traveling, during utility shutoffs, at work sites, or the like.

No devices exist which provide a portable shower or washing device, which are capable of being easily moved, and may further provide both hot and cold water for use.

A need exists for a portable shower system.

Accordingly, there is a need for a solution which is capable of use in many situations and locations to provide a portable shower or device for washing, that is capable of being easily moved.

### SUMMARY OF THE INVENTION

Advantageously, in one aspect, the present invention provides a solution which comprises a portable shower system, and a method for its use.

In one aspect, the present invention may comprise a portable shower system capable of use in for showering, washing, pet grooming, and washing cars and other vehicles.

In another aspect, the portable shower system may include a wheeled cart, and a shower apparatus including cold and hot water tanks, a water heater, and a water delivery shower head.

In a further aspect, the portable shower system includes a portable shower apparatus on a wheeled rolling cart. The portable shower apparatus comprises a shower head, at least two water tanks, and a plurality of pipes with valves operably connected to shower faucet knobs or handles. The at least two water tanks comprise a hot water tank with a water heater, and a cold water tank. The water may be heated by battery, solar panel, or combination thereof, operably connected to the hot water heater by power cords. The cart may include access doors to access the water tanks for filing and maintenance. Water pipes may be in fluid communication with the water tanks, a shower faucet and a shower head for delivery of water to the shower head. The portable shower system may offer both hot water and cold water, providing faucet handles for both hot and cold water. The invention provides a solution to the problem of a lack of portable shower facilities for indoor and outdoor use.

These and other features, aspects and advantages of the present invention will become better understood with reference to the following drawings, description and claims.

### BRIEF DESCRIPTION OF THE DRAWINGS

The preferred embodiment of the claimed subject matter will hereinafter be described in conjunction with the appended drawings provided to illustrate and not to limit the scope of the claimed subject matter, where like designations denote like elements, and in which:

FIG. 1 is a front elevation view of the invention in use in a shower stall;

FIG. 2 is a front elevation view of the invention in use as a car wash;

FIG. 3 is a schematic view of the invention; and

FIG. 4 is a schematic view of the invention without water tanks.

It is to be understood that like reference numerals refer to like parts throughout the several views of the drawings.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

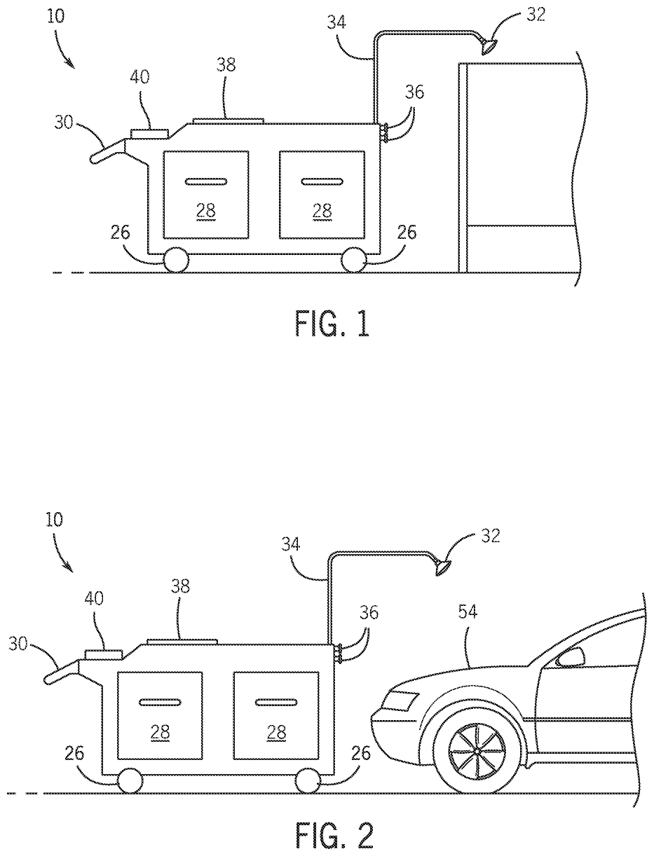

As used herein, “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, as there is no intention to be bound by any express or implied theory presented in the preceding technical field, background, brief summary or the following detailed description, it is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Broadly, one embodiment of the present invention provides a portable shower system. The portable shower system of the present invention may be used for showering and shampooing pets, and is also capable of use to wash cars or other vehicles, and to wash other articles. The portable shower system may be beneficially used in any suitable setting or situation, including but not limited to at home, during traveling, during utility shutoffs, at work sites, for pet grooming, for washing hair, for beauty salons, in laboratories, during emergencies, in situations in which using a conventional shower is not advisable, or the like.

In one embodiment the present invention may provide a portable shower system which comprises a shower apparatus on a wheeled cart. The shower apparatus may further comprise a cold water tank, a hot water tank, and a hot water heater. The system may provide a movable shower on wheels, that may resemble an indoor plumbing shower.

The system of the present invention distinguishes over and differs from previous solutions. No shower system exists which is on wheels and easily moved for use in multiple locations and settings. No other system exists which is capable of heating water, and storing both hot and cold water.

The system of the present invention provides an unprecedented solution to the problem of not having a shower, and provides a portable shower which may be easily used in any suitable setting. In some embodiments the system may be used for showering and shampooing pets, and may also be used to wash cars or other vehicles. The system may be used to wash many other articles. The system may be used in any setting, such as, for example without limitation, indoors or outdoors, at home, during traveling, during utility shutoffs, at work sites, in laboratories, during emergencies, and even in situations in which using a conventional shower and plumbing may not be advisable.

The system of the present invention may solve the problem of providing a shower in a situation in which a person's water is shut off. The user may use the system to shower in any suitable location, indoors or outdoors, outdoor camping, or may even be used for taking a shower if a national disaster prevents a person from being able to take a shower using indoor plumbing.

The present invention further distinguishes over previous devices for washing which need to be carried by hand, or do not provide sufficient hot water to enable a user to take a shower. The system of the present invention is capable of heating and storing water. The system of the present invention may include storage for both hot and cold water.

The system of the present invention may also be used as a portable washing facility for use in conventional salons for pet grooming, hair styling salons, barber shops. Further the present invention may be used for portable pet grooming salons, hair styling salons, and barber shops. In addition the system may be used for portable car washing and detailing shops.

In an exemplary embodiment the present invention may provide a portable shower or wash system comprising one or more of the following components and combinations thereof:
1. a rolling cart with wheels, with an attachable shower head;
2. a plurality of water tanks;
3. a plurality of valves;
4. a solar panel;
5. at least one battery;
6. at least two power cords;
7. at least two doors;
8. at least two water tanks;
9. a plurality of pipes; and
10. at least one shower faucet.

In an exemplary embodiment, the portable shower system may comprise a portable shower apparatus on a rolling cart. The portable shower apparatus may comprise an attachable shower head, at least two water tanks, and a plurality of valves. The at least two water tanks may comprise a first water tank and a second water tank, serving as a hot water tank and a cold water tank. The water may be heated by battery, solar power by a solar panel, or combination thereof, operably connected to the hot water heater of the hot water tank by two power cords. The solar panel and battery may be mounted to a front portion of the cart. An opening may be provided at the front of the cart where the cord may enter. The cart may include two access doors that allow access to the two water tanks. Pipes may be attached to the tanks. A large pipe may be provided in fluid communication with the hot water tank in the front portion of the cart. A relatively smaller pipe may be provided in fluid communication with the cold water tank located at the rear portion of the cart. A shower faucet may be screwed on the top of a 3″ pipe. The system of the present invention may offer both hot water and cold water and provide faucet handles for both hot and cold water.

The system and the elements or components thereof may be made of any suitable material, fabricated by any suitable method. The exact specifications and dimensions of the system and its components may vary.

In an exemplary embodiment the present invention may work or function in the following manner to provide a portable shower system that may be beneficially used to enable system users the ability to take a shower indoors or outdoors.

In some embodiments, the system may be provided with the described hot and cold water tanks. In other embodiments, the system may be provided with no water tanks, and may be constructed and arranged for connection to a water supply.

The system and its components may be made of any suitable materials, and have any suitable size and dimensions. In an exemplary embodiment, the system may include a 3-foot long pipe which may be attached at the end of a 3-feet tank mounted on a cart with four small wheels. A shower faucet may be provided for use to turn on the water. A tank enclosure may house two tanks, a first tank comprising a 2 foot tank for holding cold water and a second tank comprising a 2 foot tank for holding hot water. The hot water tank may be operably connected to a battery power source and a solar hot water heater comprising a solar panel. Two doors are provided on the outside of the tank enclosure. The user may open the tank enclosure access doors to see hot and cold water tanks and to fill the tanks with water.

In some embodiments the system may be used by pulling the tank cart to a bath tub area that does not have water access, to provide a portable indoor shower. In other embodiments, the system may be used to provide an outdoor shower. In further embodiments, the system may be used to wash any suitable item, including but not limited to a car or other vehicle.

In an exemplary embodiment the system and its components may be made of any suitable material, and by any suitable fabrication method. In some embodiments, the system may be constructed by a plumber or other person who knows about plumbing, by assembling the components in accordance with instructions that may be provided, In some embodiments the components may be provided as a kit for building the system which may further include a set of instructions for assembly, use and maintenance of the system.

In an exemplary embodiment the system may be used by providing a shower to the user when the user's conventional plumbing shower is not working. The user may further use the system to take a shower outdoors where no shower is provided, for travel, or camping in the woods. The system may be used to provide showers in hospitals when there is a shortage of showers or in labs as safety showers. The system may be used to provide outdoor showers for military personnel and campers. The system may provide showers for individuals who do not have a shower in their houses or apartments or for showers for emergency uses.

In an exemplary embodiment, the portable shower system may comprise one or more of the following elements or components and combinations thereof:
a portable shower cart;
a plurality of cart wheels;
a plurality of cart doors;
at least one cart handle;
at least one shower head;
at least one flexible shower hose; and
a plurality of faucet handles which may be at least one pair of faucet turn knobs..

In some embodiments, the system may further comprise at least one flexible water hose in fluid communication with the at least one flexible shower hose and the at least one shower head, whereby the at least one flexible water hose of the system may be connected to an existing water supply, and the at least one pair of faucet turn knobs may be turned to open a valve associated therewith to enable water from the water supply to flow from the at least one shower head.

In some embodiments, the system may further comprise:
at least one solar panel;
at least one battery; and
a plurality of water tanks including at least one hot water tank and a least one cold water tank.

Water may be provided for storage in the at least one cold water tank, and in the at least one hot water tank. The at least one hot water tank may include a water heater operated by the at least one solar panel, the at least one battery, or a combination thereof. The solar panel may be operably connected to the hot water heater of the hot water tank and to the battery by power cords. The at least one pair of faucet turn knobs may be turned to open a valve associated therewith to enable water from the water supply to flow from the at least one shower head.

The system may be used indoors or outdoors. In some embodiments, the system may be used indoors in a bathroom tub or shower stall, or for other indoor uses. The system may be used by pulling the cart to a bath tub area that does not have water access, to provide a portable indoor shower. In some embodiments, the system may be used outdoors with an outdoor shower enclosure. In some embodiments, the system may be used outdoors to wash a car, any vehicle or any other item or structure.

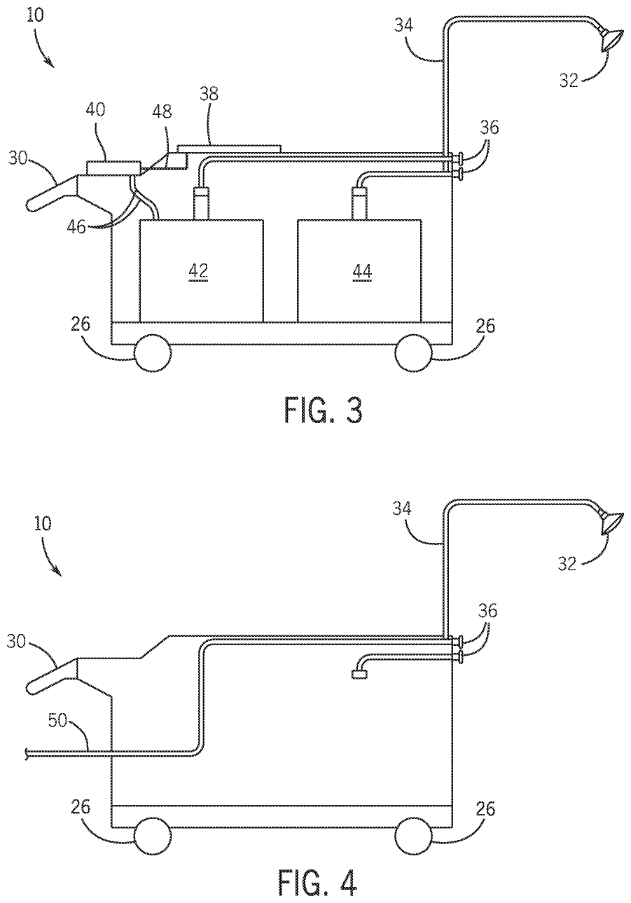

Referring to FIGS. 1-4, the portable shower system is shown generally at 10. FIG. 1 provides a side elevation view of the system 10 in use in an exemplary indoor use such as, for example without limitation, with a shower stall. FIG. 2 shows a side elevation view of the system 10 in an exemplary outdoor use, such as, for example without limitation, as a car wash. FIG. 3 provides a schematic side view of the system 10 interior of the cart 12, and FIG. 4 shows a side schematic view of the system 10 interior of the cart 12 without water tanks.

In an exemplary embodiment, the system 10 may comprise a cart 12 having a front portion, a rear portion, a top, a bottom, a right side and a left side. The views of the system at FIGS. 1-4 show the right side of the cart 12. In some embodiments, the elements or components of the system shown at from the right side view may be provided at or on the left side of the cart. The cart includes at least three wheels. In some embodiments the cart may have four wheels 26, two front wheels and two rear wheels. The cart may have a first door and a second door located at the right side or left side of the cart. In an exemplary embodiment, doors 28 are provided at the right side of the cart 12. The cart 12 includes at least one handle 30 located at the front portion of the cart. In some embodiments, the cart 12 may have two handles. The cart may support at its rear portion, a shower head 32 in fluid communication with a flexible shower hose 34, operably connected to a pair of faucet handles 36.

The system 10 includes a solar panel 38 and a battery 40. In some embodiments, the solar panel 38 and battery 40 are located at and mounted to the front portion of the cart 12. The system further includes a first tank and a second tank. The first tank is a hot water tank 42 and the second tank is a cold water tank 44. The water in the hot water tank 42 may be heated by battery, solar power by the solar panel, or combination thereof. The solar panel 38 may be operably connected to a hot water heater of the hot water tank by two power cords 46, and to the battery by a power cord 48.

As seen at FIG. 1, the system 10 may be used in association with a shower stall 52. In some embodiments, the system 10 may be used by pulling the tank cart 12 to a bath tub or shower area that does not have water access, to provide a portable indoor shower. The shower stall may further be an outdoor shower enclosure.

As seen at FIG. 2, the system may be used to wash a car 54. As noted hereinabove, the system may be used to wash any vehicle or other structure.

As seen at FIG. 4, the system may include a water hose 50, by which the portable shower may be in fluid communication with any conventional water source indoor or outdoor.

In an exemplary embodiment, the present invention provides a portable shower system for indoor or outdoor use. The portable shower system comprises: a portable shower cart comprising a wheeled base including a plurality of wheels, a cart housing including a plurality of cart doors, and at least one cart steering handle; and a portable shower apparatus carried by the portable shower cart. The portable shower apparatus further comprises at least one shower head; at least one flexible shower hose; and a plurality of faucet turn knobs which may be at least one pair of faucet turn knobs. The portable shower apparatus is constructed and arranged for delivery of water from a water source through the at least one flexible shower hose, and out of the at least one shower head, in response to a user rotating the at least one pair of faucet turn knobs.

In some embodiments, the water source comprises an existing water supply; and the portable shower apparatus further comprises at least one flexible water hose in fluid communication with the at least one flexible shower hose and the at least one shower head. The at least one flexible water hose of the portable shower apparatus may be connected to the existing water supply, and the at least one pair of faucet turn knobs may be rotated to open a valve associated therewith to enable water from the existing water supply to flow from the at least one shower head.

In some embodiments, the portable shower apparatus further comprises at least one solar panel; at least one battery; at least two power cords; and a water source.. The at least two power cords further comprise a first power cord and a second power cord. The water source further comprises a plurality of water tanks including at least one hot water tank and a least one cold water tank, the plurality of water tanks being constructed and arranged for storage of water. The at least one hot water tank further includes a water heater operably connected to the at least one solar panel, the at least one battery or a combination thereof by the first power cord. The solar panel is operably connected to the battery by the second power cord. The at least one pair of faucet turn knobs may be rotated to open a valve associated therewith to enable delivery of water from the at least one hot water tank and the at least one cold water tank to flow from the at least one shower head.

In some embodiments, the portable shower system may be constructed and arranged for use indoors. The portable shower system may be used in association with an existing indoor bathtub or shower stall. Nonlimiting examples of indoor settings in which the portable shower system may be used, include dwellings, hotels, temporary housing structures, hospitals, medical facilities, laboratories, schools, military bases, pet grooming salons, beauty salons, barber shops, and combinations thereof.

In some embodiments, the portable shower system may be constructed and arranged for use outdoors. The portable shower system may be used in association with an existing outdoor shower facility. Nonlimiting examples of outdoor settings at which the portable shower system may be used, include work sites, camp sites, military camps, emergency sites and combinations thereof.

The portable shower system may be constructed and arranged for use to wash a vehicle, a structure or an item located outdoors.

In some embodiments, the portable shower system further comprises a vehicle in which the portable shower cart and the portable shower apparatus are removably located.

In summary, the present invention provides a portable shower system comprising a portable shower apparatus on a wheeled cart. The system includes a cold water storage tank, a hot water storage tank, a hot water heater and a shower delivery head. The system may be used to provide a portable shower for multiple indoor and outdoor settings and uses.

In an exemplary embodiment, the portable shower system may comprise a portable shower apparatus on a rolling cart. The portable shower apparatus may comprise a shower head, at least two water tanks, and a plurality of valves operably connected to shower faucet knobs or handles. The at least two water tanks may comprise a hot water tank with a hot water heater, and a cold water tank. The water may be heated by battery, solar power by a solar panel, or combination thereof, operably connected to the hot water heater of the hot water tank by two power cords. The cart may include two access doors that allow access to the water tanks. Water pipes may be attached to the tanks. A large pipe may be provided in fluid communication with the hot water tank, and a relatively smaller pipe may be provided in fluid communication with the cold water tank. The shower faucet and shower head may be screwed on the top of a pipe and in fluid communication with the pipe. The system of the present invention may offer both hot water and cold water and provide faucet handles for both hot and cold water. The invention provides a solution to the problem of a lack of portable shower facilities.

It should be understood, of course, that the foregoing relates to exemplary embodiments of the invention and that modifications, variations and changes in detail may be made without departing from the spirit and scope of the invention as set forth in the following claims.

What is claimed is:

1. A portable shower system for indoor or outdoor use, the portable shower system comprising:
a portable shower cart comprising a wheeled base including a plurality of wheels, a cart housing including a plurality of cart doors, and at least one cart steering handle; and
a portable shower apparatus carried by the portable shower cart, the portable shower apparatus further comprising:
at least one shower head;
at least one flexible shower hose; and
a plurality of faucet turn knobs which may be at least one pair of faucet turn knobs;
wherein the portable shower apparatus is constructed and arranged for delivery of water from a water source through the at least one flexible shower hose, and out of the at least one shower head, in response to a user rotating the at least one pair of faucet turn knobs.

2. The portable shower system of claim 1, wherein:
the water source comprises an existing water supply; and
the portable shower apparatus further comprises at least one flexible water hose in fluid communication with the at least one flexible shower hose and the at least one shower head, whereby the at least one flexible water hose of the portable shower apparatus may be connected to the existing water supply, and the at least one pair of faucet turn knobs may be rotated to open a valve associated therewith to enable water from the existing water supply to flow from the at least one shower head.

3. The portable shower system of claim 1, wherein:
the portable shower apparatus further comprises:
at least one solar panel;
at least one battery;
at least two power cords, further comprising a first power cord and a second power cord; and
a water source, the water source further comprising a plurality of water tanks including at least one hot water tank and a least one cold water tank, the plurality of water tanks being constructed and arranged for storage of water, the at least one hot water tank further including a water heater operably connected to the at least one solar panel, the at least one battery or a combination thereof by the first power cord;
the solar panel is operably connected to the battery by the second power cord; and
the at least one pair of faucet turn knobs may be rotated to open a valve associated therewith to enable delivery of water from the at least one hot water tank and the at least one cold water tank to flow from the at least one shower head.

4. The portable shower system of claim 1 constructed and arranged for use indoors.

5. The portable shower system of claim 4 constructed and arranged for use with an existing indoor bathtub or shower stall.

6. The portable shower system of claim 4 constructed and arranged for use in a location selected from dwellings, hotels, temporary housing structures, hospitals, medical facilities, laboratories, schools, military bases, pet grooming salons, beauty salons, barber shops, and combinations thereof.

7. The portable shower system of claim 1 constructed and arranged for use outdoors.

8. The portable shower system of claim 7 constructed and arranged for use with an existing outdoor shower facility.

9. The portable shower system of claim 7 constructed and arranged for use at a location selected from work sites, camp sites, military camps, emergency sites and combinations thereof.

10. The portable shower system of claim 7 constructed and arranged for use to wash a vehicle.

11. The portable shower system of claim 7 constructed and arranged for use to wash a structure or an item located outdoors.

12. The portable shower system of claim 1 further comprising a vehicle in which the portable shower cart and the portable shower apparatus are removably located.
